(19) United States
(12) Patent Application Publication
(10) Pub. No.: US 2002/0079839 A1
(43) Pub. Date: Jun. 27, 2002

(54) Sealing vessel, method for manufacturing thereof and a display apparatus using such sealing vessel

(76) Inventor: Kiyoshi Kokubu, Kanagawa (JP)

Correspondence Address: COOPER & DUNHAM LLP, 1185 Avenue of the Americas, New York, NY, 10036, US

(21) Appl. No.: 09/943,686

(22) Filed: Aug. 31, 2001

(30) Foreign Application Priority Data
Sep. 6, 2000 (JP) P2000-269529

(51) Int. Cl. H01J 17/24

(52) U.S. Cl. 313/562

(57) ABSTRACT

A sealing vessel of this invention comprises a pair of flat plates; a frame member pinched between the pair of flat plates; a adhering member for sealing a space provided inside of the frame member by adhering the pair of flat plates at outer periphery of the frame member; and a pair of fixing blocks for coupling the pair of flat plates at outside of the frame member.

### CROSS REFERENCE TO RELATED APPLICATIONS

This application claims priority from Japanese Priority Document No. 2000-269529, filed on Sep. 6, 2000 with the Japanese Patent Office, which document is hereby incorporated by reference.

### BACKGROUND OF THE INVENTION

1. Field of the Invention

The present invention relates to a sealing vessel that is provided with a pair of flat plates with a predetermined space to be sealed there-between, a manufacturing method thereof, and a display apparatus using such sealing vessel.

2. Related Art

In recent years, various types of flat-type display apparatuses such as a LCD (Liquid Crystal Display), a PDP (Plasma Display Panel) and a FED (Field Emission Display) have been developed as a display apparatus to be replaced with a conventional CRT (Cathode Ray Tube) display apparatus.

In such flat-type display apparatus, two pieces of thin glass plates are disposed with a predetermined space there-between, and display pixels and wiring are formed within an internal space between these two glass plates by respectively related technologies. For example, in case of the PDP, a front substrate formed with electrodes and a back substrate formed with a fluorescent layer are respectively provided in facing relation to each other, and both peripheral portions of these two substrates are sealed so as to keep discharging gas in inside.

Further in case of the FED, a cathode substrate provided with a micro electric field emission cathode in a matrix form and an anode substrate formed with a fluorescent layer are respectively adhered via a spacer, and peripheral portions of these two substrates are sealed so as to keep vacuum in inside.

In the display apparatus such as the PDP or the FED, a frame-shaped low melting point glass is pasted on periphery surrounding a display region on a surface of one of glass substrates and then both glass substrates are aligned in facing relation, as one of methods for adhering two pieces of thin glass substrates. Practically, such low melting point glass is pasted by means of a screen printing with a mask having frame-shaped pattern, and then formed by temporal burning.

A heat-treatment around 450° C. is then applied to the both substrates that are mutually depressed to each other via the low melting point glass in a non-active gas atmospheres. Thereby the low melting point glass is softened and the both substrates are adhered. After that, the inside space formed by the both substrates is formed a vacuum through an exhaust tube previously attached to the glass substrates. And in a vacuum condition, the exhaust tube is burnt out to close an exhaust exit.

However, in case of adhering these two pieces of substrates by the above-mentioned method, a final adhering process is done by softening the low melting point glass with a heating furnace after temporarily fixing the aligned two substrates by clips. In this case, until the final adhering process is applied, dislocation of the aligned two substrates tends to be occurred due to vibration upon conveyance of these substrates and a thermal influence in the heating furnace.

Then instead of using such low melting point glass process, an anode junction process is applied to seal the both substrates (cf. Japanese Laid-Open Patent No. H7-122189), or a technology for combining the anode junction process and the low melting point glass process is applied to seal the two substrates (cf. Japanese Laid-Open Patent No. H7-161299, and Japanese Laid-Open Patent No. H11-233003).

However, there are many problems in the disclosed technologies. Namely, silicon material or the like is necessary as a adhering material in the above mentioned anode junction process, and a adhering time is elongated because of the necessity of application of heat, a vacuum, and high voltage upon adhering. Furthermore, when the glass substrates to be adhered are large in area, it is difficult to complete a perfect vacuum seal by the anode junction process, because the sealing length becomes larger.

In addition, in a display apparatus such as the above-mentioned FED, it is necessary to provide a getter in order to maintain an internal vacuum degree after sealing the two substrates. The getter has to be provided close to the display area and also has to have a large area enough to execute adequate getter function. In the conventional FED, the getter is put in another vessel, and is attached on back of the display area, or the getter is provide at a bottom of an emitter with a 3-layered construction by adhering these substrates (cf. Japanese Laid-Open Patent No. H11-233003). However in this case, the other vessel becomes necessary, and the structure becomes much complicated in the above-described conventional technologies.

### SUMMARY OF THE INVENTION

A sealing vessel of the present invention comprises a pair of flat plates, a frame member pinched between the pair of flat plates, a adhering member for sealing a space formed inside of the frame member by adhering the pair of flat plates at peripheral part of the frame member and fixing blocks for connecting the pair of flat plates at periphery of the frame member.

According to the present invention, the pair of flat plates are connected by fixing blocks, so that when the pair of flat plates are sealed together with the frame member in-between, the alignment condition of the pair of flat plates can be firmly fixed with the fixing blocks, and thereby the pair of flat plates can be adhered without any dislocation.

Further in another aspect of this invention, a sealing vessel comprises a pair of flat plates, a frame member pinched between the pair of flat plates, a adhering member for sealing a space formed inside of the frame member by adhering the pair of flat plates at peripheral part of the frame member and a getter material adhered to inner surface of the frame member.

According to the present invention, a getter material is attached to inner peripheral surface of the frame member that is pinched between a pair of flat plates, so that the inner peripheral area of the frame member can effectively absorb air or gas without providing an additional substrate structure for a getter.

In addition, a method of manufacturing a sealing vessel of the present invention comprises the steps of a step for providing a frame member between a pair of flat plates and for coupling said pair of flat plates by a fixing block at outside of said frame member; and a step for adhering said pair of flat plates at outer periphery of said frame member and for sealing a space formed inside of said frame member. Accordingly as the outer periphery of the frame member provided between them is adhered with adhering material while coupling the pair of flat plates by the fixing blocks, the positional alignment is firmly kept by the fixing block during interval from the positional alignment of the flat plates to the sealing process by the adhering material. Therefore the pair of flat plates can be fixed and sealed without dislocation.

### BRIEF DESCRIPTION OF THE DRAWINGS

In the accompanying drawings:

FIG. 1 is a sectional view for explaining a sealing vessel related to the present invention;

FIGS. 2A, 2B and 2C are charts for explaining a frame member made of a glass;

FIG. 3 is a cross-sectional view of an end portion for explaining an embodiment of manufacturing method related to the present invention;

FIG. 4 is a cross-sectional view of the end portion for explaining the embodiment of manufacturing method related to the present invention;

FIG. 5 is a plan view for explaining a manufacturing method related to the present invention; and

FIG. 6 is a cross-sectional view of the end portion for explaining the embodiment of manufacturing method related to the present invention.

### DETAILD DESCRIPTION OF THE EMBODIMENTS

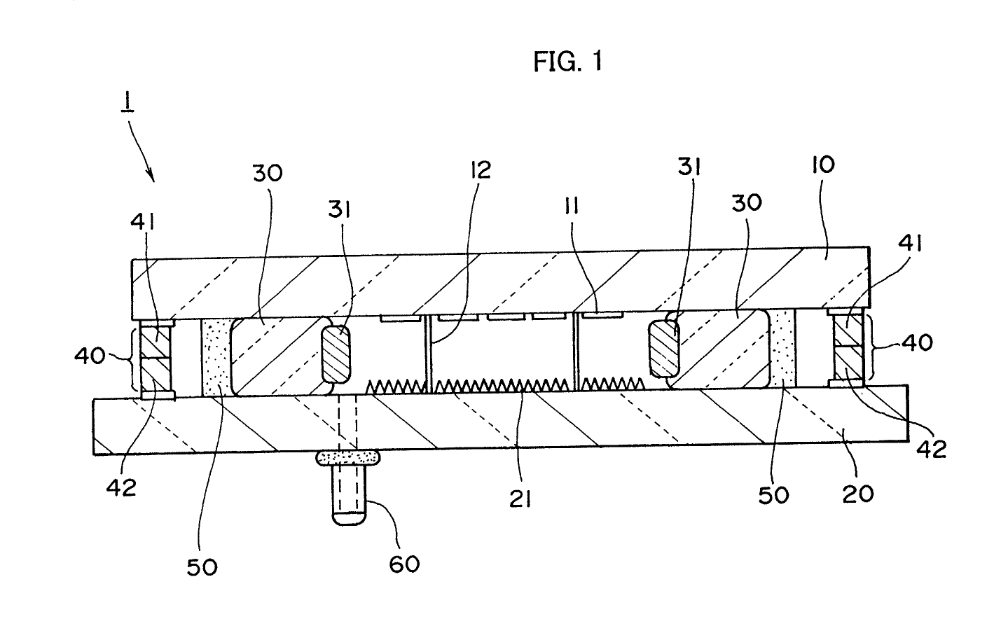

Detailed description of the preferred embodiment of the present invention is explained based on accompanying drawings as follows. FIG. 1 shows a sectional view for explaining a sealing vessel related to an embodiment of the present invention. The sealing vessel of the present embodiment is mainly applied to a display apparatus and a display apparatus 1 of this embodiment is a FED (Field Emission Display), for example.

In this display apparatus 1, a frame glass 30 is pinched between an anode substrate 10 and a cathode substrate 20 and the sealing vessel is comprised by sealing outer periphery of the frame glass 30 with a low melting point glass 50.

The anode substrate 10 comprises of a flat glass plate and a fluorescent material 11 of R (red), G (green) and B (blue) are sequentially formed on a surface opposing to the cathode substrate 20. The cathode substrate 20 also comprises of a flat glass plate and a lot of micro cathode-emitters 21 are formed as a field emission cathode on a surface opposing to the anode substrate 10. In addition, on the cathode substrate 20, an exhaust tube 60 is attached for forming a vacuum in the inside space after sealing.

For example, in the FED, the anode substrate 10 is about 1 mm thick, the cathode substrate 20 is also about 1 mm thick and a space between both substrates 10 and 20 is around 2 mm thick, and further it is necessary to seal these anode substrate 10 and cathode substrate 20 in a condition where these substrates 10 and 20 are precisely aligned and the space is kept maintained.

In the present embodiment, the frame glass 30 is pinched between the anode substrate 10 and the cathode substrate 20, and the space between the both substrates is able to be set precisely. In this case, the gap at a central part of the space formed between the anode substrate 10 and the cathode substrate 20 are held maintained by a spacer 12.

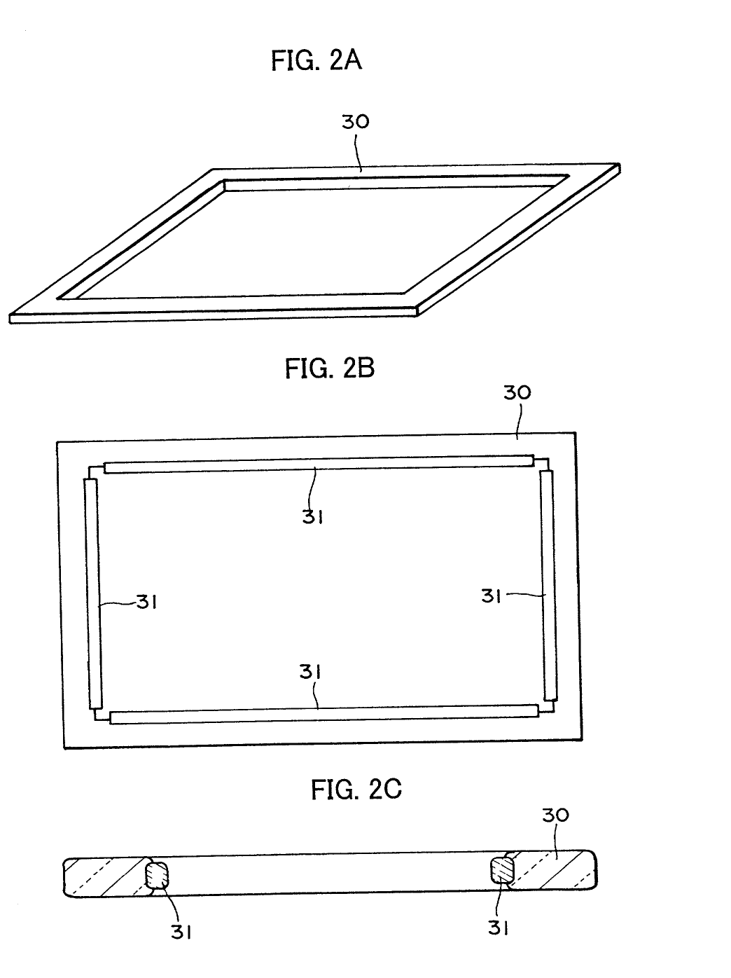

FIG. 2A, FIG. 2B and FIG. 2C are a perspective view, a plan view and a cross-sectional view, respectively for explaining the frame glass 30. The frame glass 30 becomes a frame member surrounding display area and positioned at outside of the display area of the display apparatus 1. Accordingly by pinching the frame glass 30 with the anode substrate 10 and the cathode substrate 20, the space between the both substrates 10 and 20 can be precisely maintained without being influenced by an unstable film thickness of such low melting point glass 50.

In addition, in the present embodiment, a getter 31 is adhered to an inner wall of the frame glass 30. The getter 31 comprises of non-evaporation type material (for example, Barium or Titanium) and attached to the inner wall of the frame glass 30 by deposition process or insertion process.

In this case, an area for attaching the getter 31 is preferably increased by forming unevenness on the inner wall of the frame glass 30 by a sandblast process or other machining. Thereby, the construction of the vessel becomes simple without preparing another parts for the getter 31, and an effective gas absorbing effect can be obtained at the display area.

In addition, the display apparatus 1 of the present embodiment comprises a fixed block 40 to couple the space between the anode substrate 10 and the cathode substrate 20 at outside of the frame glass 30. This fixed block 40 is split into two pieces, and a first fixed block 41 is fixed to the anode substrate 10 and a second fixed block 42 is fixed to the cathode substrate 20. The both fixing blocks 41 and 42 are impinged to each other when the anode substrate 10 and the cathode substrate 20 are superposed to each other.

This fixed block 40 is temporally fixed not to dislocate the anode substrate 10 and the cathode substrate 20 during the interval from the aligning process of the anode substrate 10 and the cathode substrate 20 to the sealing process with the low melting point glass 50.

In other words, after superposing and positioning the anode substrate 10 and the cathode substrate 20, the both fixing blocks 41 and 42 are adhered to each other at abutting position.

The first fixed block 41 and the second fixed block 42 are made of metal material having a thermal expansion coefficient similar to that of the anode substrate 10 and the cathode substrate 20, and a laser welding or an ultra-sonic wave welding that is able to fix in a moment can be used.

A positional relation of the anode substrate 10 and the cathode substrate 20 becomes possible to be precisely maintained by this adhering, it becomes possible to prevent dislocations due to the vibration caused when conveying it to a heating furnace for softening the low melting point glass 50 or dislocations caused by heating process after that.

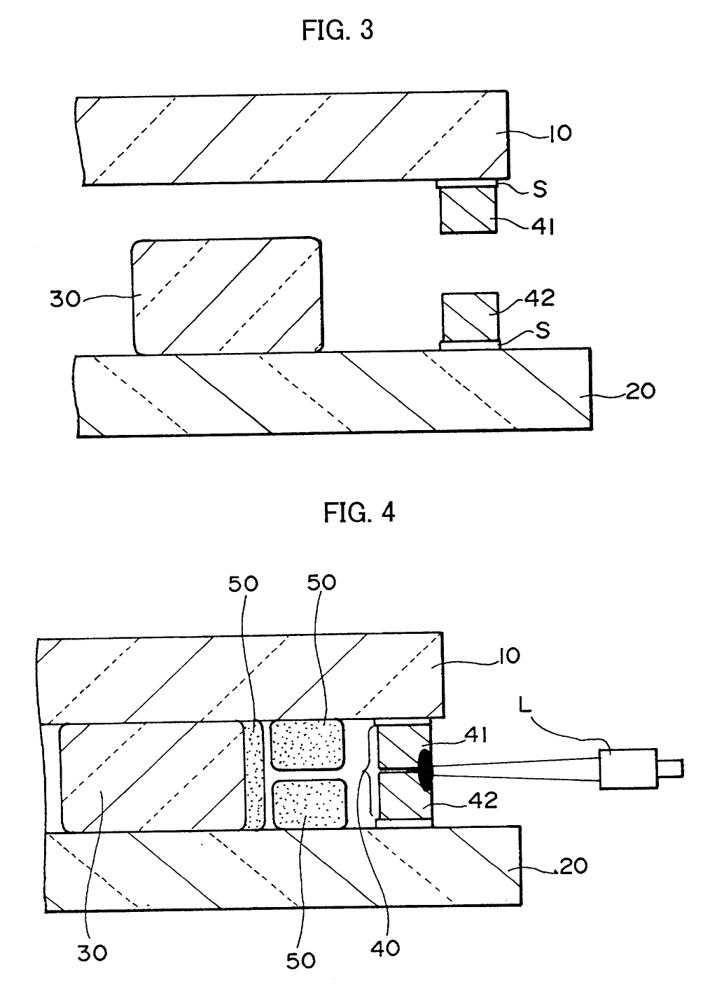

Now a method of manufacturing a sealing vessel of the present embodiment is explained in detail. In this embodiment, an FED is used as an example of the display apparatus 1. At first, as shown in FIG. 3, the first fixed block 41 is attached to the peripheral part of the anode substrate 10 by glue S or a ultra-sonic wave welding process and the second fixed block 42 is also attached to the peripheral part of the cathode substrate 20 by glue S or the ultra-sonic wave welding process.

The first fixed block 41 and the second fixed block 42 are made of metal material having a thermal expansion coefficient similar to that of the anode substrate 10 and the cathode substrate 20 (for example, Nickel alloy and Covar). In addition, surfaces of the first fixed block 41 and the second fixed block 42 are highly finished in order to precisely decide the space between the anode substrate 10 and the cathode substrate 20 when superposing the both substrates 10 and 20 to each other.

In this embodiment, the space formed between the anode substrate 10 and the cathode substrate 20 is set to be equal or a little larger than the thickness of the frame glass 30 when the first fixed block 41 and the second fixed block 42 are superposed to each other. Accordingly, it becomes possible to suppress a huskiness caused by the contact of the anode substrate 10 or the cathode substrate 20 with the frame glass 30 when superposing the anode substrate 10 and the cathode substrate 20 via the frame glass 30.

Further as shown in FIG. 4, the low melting point glass 50 for vacuum sealing is painted to each of opposing surfaces of the anode substrate 10 and the cathode substrate 20 by a dispense method, and the painted low melting point glass 50 is rigidified by a temporal burning, and further the low melting point glass 50 formed as a flat plate by powder sintering is provided at outer peripheral surface of the frame glass 30.

In this case, each thickness of the low melting point glass 50 attached to the anode substrate 10 and the cathode substrate 20 is preferably such that there causes a small space between substrates when the both substrates 10 and 20 are superposed to each other. In addition, the low melting point glass 50 attached to the outer peripheral surface of the frame glass 30 may be attached in advance and further, it is not necessary if the low melting point glass 50 attached to the anode substrate 10 and the cathode substrate 20 serves its functions adequately.

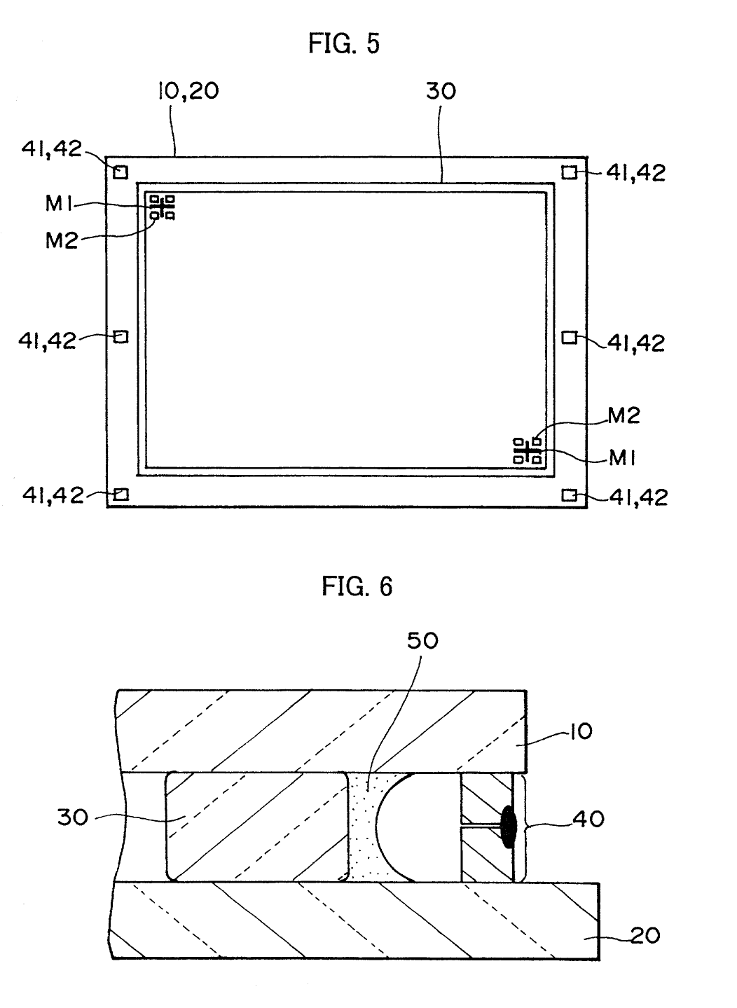

Next, the positional alignment of the anode substrate 10 and the cathode substrate 20 is done via the frame glass 30 in this state. As shown in FIG. 5, the positional alignment of the anode substrate 10 and the cathode substrate 20 is done with reference to two marks M1 and M2. Namely, the mark M1 provided on the anode substrate 10 is accorded with the mark M2 provided on the cathode substrate 20 as a positional reference.

Practically, each mark M1 and M2 is detected by an image processing using a TV camera and the positional alignment is carried out by the detected results of the image processing. In accordance with this positional alignment, the first fixed block 41 provided on the anode substrate 10 and the second fixed block 42 provided on the cathode substrate 20 is correctly positioned in facing relation to each other.

In addition, an arrangement position and the number of the fixing block 40, namely each pair of the first fixed block 41 and the second fixed block 42, are determined in accordance with the size of the anode substrate 10 and the cathode substrate 20. In the embodiment of FIG. 5, actually six fixing blocks 40 are preferably provided as shown. In addition, the fixing block 40 is preferably kept apart from the wiring pattern formed on the cathode substrate 20. This is for reducing the influence to the wiring pattern by the laser welding.

Namely, the anode substrate 10 and the cathode substrate 20 are slightly depressed to each other and then, the laser welding is applied to a contact portion of the one side fixed block 41 and the second fixed block 42 by irradiating a laser beam from a laser head L to the contact portion. Thereby the first fixed block 41 and the second fixed block 42 is welded in a moment and the positional aligning condition of the anode substrate 10 and the cathode substrate 20 is certainly maintained.

Further as shown in FIG. 6, the space between the anode substrate 10 and the cathode substrate 20 is sealed in outside of frame glass 30 by softening with heat the low melting point glass 50 interposed between the anode substrate 10 and the cathode substrate 20. In case of conducting this sealing process, positionally aligned anode substrate 10 and the cathode substrate 20 are conveyed to a heating furnace, but the alignment condition of the anode substrate 10 and the cathode substrate 20 is maintained by the laser welding at the previous stage, so that the positional alignment of the both substrates does not dislocate by the vibration upon conveying.

The heating furnace becomes a non-active gas atmosphere and can apply heat of 450° C. for around 30 minutes to soften the low melting point glass 50. In case of conveying the substrates into the heating furnace, the anode substrate 10 is preferably positioned on top of the cathode substrate 20.

The low melting point glass 50 softens by this heat process, and the sealed space is formed inside of the frame glass 30, because the boundary of the both substrates is buried with the softened low melting point glass 50. Even during the heating process, the anode substrate 10 and the cathode substrate 20 are coupled by the fixed block 40, so that the both substrates 10 and 20 do not dislocate to each other by the thermal influence.

In the FED, the getter 31 (cf. FIG. 1) is attached on the inner wall of the frame glass 30 in advance. Thereby it becomes possible to absorb unnecessary gas without adopting another substrate structure proper to the getter 31. In particular, it is effective when the space between the anode substrate 10 and the cathode substrate 20 is relatively large such as around 2 mm.

After the sealing vessel is formed, the air is exhausted through the exhaust tube 60 provided on the cathode substrate 20 (cf. FIG. 1), and after that, the exhaust pipe 60 is burned out to seal the exhaust exit. Lastly, the getter 31 is heated to activate, and unnecessary gas in the sealing vessel is adsorbed thereby to form a high vacuum. By this, it becomes possible to manufacture a FED, wherein the positional alignment of the anode substrate 10 and the cathode substrate 20 is precisely determined.

In addition, in the above-described embodiment, the display apparatus employing a flat glass substrate as a flat plate is described, but the present invention is not limited to this embodiment, and the present invention can be applied to a case where a flat plate made of resin is employed. In addition, this invention can be applied to a flat-type display apparatus other than the FED.

What is claimed is:

1. A sealing vessel comprising:
a pair of flat plates;
a frame member pinched between said pair of flat plates;
a adhering member for sealing a space provided inside of said frame member by adhering said pair of flat plates at outer periphery of said frame member; and
a fixing block means for coupling said pair of flat plates at outside of said frame member.

2. The sealing vessel as claimed in claim 1, wherein said fixing block means is fixed to each of said flat plates.

3. The sealing vessel as claimed in claim 1, wherein
said fixing block means includes a pair of fixing blocks attached to respective one side and the other side of said pair of flat plates, and
each of said fixing blocks attached to said one side and the other side of the flat plates is adhered to each other at a superposed position.

4. The sealing vessel as claimed in claim 3, wherein
each of said fixing blocks comprises of metal material and is adhered to each other by welding at the superposed position.

5. The sealing vessel as claimed in claim 1, wherein
each of said flat plates comprises of a glass substrate.

6. The sealing vessel as claimed in claim 1, wherein
said adhering member comprises of low melting point glass material.

7. A sealing vessel comprising:
a pair of flat plates;
a frame member pinched between said pair of flat plates;
a adhering member for sealing a space formed inside of said frame member by adhering said pair of flat plates at outer periphery of said frame member; and
a getter material attached to an inner surface of said frame member.

8. A method of manufacturing a sealing vessel comprising the steps of
a step for providing a frame member between a pair of flat plates and for coupling said pair of flat plates by a fixing block means at outside of said frame member; and
a step for adhering said pair of flat plates at outer periphery of said frame member and for sealing a space formed inside of said frame member.

9. The method of manufacturing a sealing vessel as claimed in claim 8, wherein
said fixing block means includes a pair of fixing blocks attached to respective one side and the other side of said pair of flat plates; and
each of said fixing blocks attached to said one side and the other side of the flat plates is adhered to each other at a superposed position.

10. The method of manufacturing a sealing vessel as claimed in claim 8, wherein
each of said fixing blocks comprises of metal material and is adhered to each other by welding at the superposed position.

11. The method of manufacturing a sealing vessel as claimed in claim 8, wherein
each of said flat plates comprises of a glass substrate.

12. The method of manufacturing a sealing vessel as claimed in claim 8, wherein
said adhering member comprises of low melting point glass material.

13. A display apparatus comprising:
a pair of flat plates;
a frame member pinched between said pair of flat plates;
a adhering member for sealing a space provided inside of said frame member by adhering said pair of flat plates at outer periphery of said frame member; and
a fixing block means for coupling said pair of flat plates at outside of said frame member.

14. The display apparatus as claimed in claim 13, wherein
said fixing block means is fixed to each of said flat plates.

15. The display apparatus as claimed in claim 13, wherein
said fixing block means includes a pair of fixing blocks attached to respective one side and the other side of said pair of flat plates, and
each of said fixing blocks attached to said one side and the other side of the flat plates is adhered to each other at a superposed position.

16. The display apparatus as claimed in claim 15, wherein
each of said fixing blocks comprises of metal material and is adhered to each other by welding at the superposed position.

17. The display apparatus as claimed in claim 13, wherein
said adhering material comprises of low melting point glass material.

18. The display apparatus as claimed in claim 13, further comprising:
a getter material attached to an inner surface of said frame member.
